(19) United States
(12) Patent Application Publication
(10) Pub. No.: US 2021/0222578 A1
(43) Pub. Date: Jul. 22, 2021

(54) FLUID CONTROL DEVICE AND ROTARY MACHINE

(71) Applicant: MITSUBISHI HEAVY INDUSTRIES, LTD., Tokyo (JP)

(72) Inventors: Kodai IWATSU, Tokyo (JP); Makoto IWASAKI, Tokyo (JP); Teruaki YAMAWAKI, Tokyo (JP)

(21) Appl. No.: 17/149,173

(22) Filed: Jan. 14, 2021

(30) Foreign Application Priority Data
Jan. 17, 2020 (JP) 2020-005731

(51) Int. Cl. F01D 11/02; F16J 15/447

(52) U.S. Cl. CPC F01D 11/02; F01D 11/001; F16J 15/4472

(57) ABSTRACT

There is provided a fluid control device included in a rotary machine including a rotor, a case provided to surround an outer side of the rotor, and seal fins each provided to protrude from at least one of the rotor or the case, and configured to control a swirling flow flowing between the seal fin and the rotor or between the seal fin and the case. The fluid control device includes a first fluid control device configured to generate an induced flow in a backflow direction opposite to a flow direction of the swirling flow in an axial direction of the rotor.

### CROSS-REFERENCE TO RELATED APPLICATIONS

This application claims the benefit of priority to Japanese Patent Application Number 2020-005731 filed on Jan. 17, 2020. The entire contents of the above-identified application are hereby incorporated by reference.

### TECHNICAL FIELD

The disclosure relates to fluid control devices and rotary machines.

### RELATED ART

As a fluid control device, a leakage flow rate reduction device for a fluid machine in which leakage of a working fluid through a tip clearance formed between an outer end of a rotating blade and an inner circumferential surface of a casing is prevented has been known (for example, see JP 2017-53261 A). The leakage flow rate reduction device for the fluid machine is a wire type plasma actuator, and includes an insulation-coated conductive wire provided at a position facing the outer end of the blade on the inner circumferential surface of the casing. In the wire type plasma actuator, a voltage is applied to a conductive wire being not insulation-coated, and the outer end of the blade is grounded, whereby plasma discharge is generated between the conductive wire and the outer end of the blade, and an induced airflow is generated along with the plasma discharge.

### SUMMARY

In a rotary machine including a rotor, a portion between the rotor and a casing provided around the rotor is sealed. Seals for such sealing include a labyrinth seal using a plurality of seal fins. The plurality of seal fins are respectively provided on the rotor and the casing. By bringing the tips of the seal fins close to the rotor and the casing, the gap between the seal fin and the rotor and the gap between the seal fin and the casing are made small, so that the leakage of a fluid from the gap between the seal fin and the rotor and from the gap between the seal fin and the casing is suppressed.

A flow (swirl) of the fluid in the circumferential direction is generated around the rotor along with the rotation of the rotor. When the swirl is generated, the pressure distribution in the circumferential direction of the rotor becomes non-uniform, and displacement in the radial direction of the rotor occurs, whereby the rotor is excited. A force that excites the rotor in the sealing portion is referred to as a seal excitation force. The seal excitation force increases as the gap between the seal fin and the rotor and the gap between the seal fin and the casing are smaller.

In JP 2017-53261 A, a leakage flow rate reduction structure by the conductive wire and the blade outer end is not possible to be used along with a leakage flow rate reduction structure by the existing labyrinth seal, and therefore a leakage flow rate reduction effect may not be sufficiently obtained. In this case, the gap between the conductive wire and the blade outer end has to be reduced in order to lessen the leakage flow rate, which may lead to an increase in the seal excitation force.

Thus, an object of the disclosure is to provide a fluid control device and a rotary machine able to suppress leakage of a fluid and reduce an excitation force exerted on a rotor.

A fluid control device of the disclosure is a fluid control device included in a rotary machine including a rotor, a case provided to surround an outer side of the rotor, and a fin provided to protrude from at least one of the rotor or the case, and configured to control a fluid that flows between the fin and the rotor or between the fin and the case, the fluid control device including a first fluid control device configured to generate an induced flow in a backflow direction opposite to a flow direction of the fluid in an axial direction of the rotor.

A fluid control device of the disclosure is a fluid control device included in a rotary machine including a rotor, a case provided to surround an outer side of the rotor, and a fin provided to protrude from at least one of the rotor or the case, and configured to control a fluid that flows between the fin and the rotor or between the fin and the case, the fluid control device including a second fluid control device configured to generate an induced flow in a circumferential direction of the rotor.

A fluid control device of the disclosure is a fluid control device included in a rotary machine including a rotor, a case provided to surround an outer side of the rotor, and a fin provided to protrude from at least one of the rotor or the case, and configured to control a fluid that flows between the fin and the rotor or between the fin and the case, the fluid control device including a third fluid control device configured to generate an induced flow in a radial direction of the rotor.

A rotary machine of the disclosure includes a rotor, a case provided to surround an outer side of the rotor, a fin provided to protrude from at least one of the rotor or the case, and the above-described fluid control device configured to control a fluid that flows between the fin and the rotor or between the fin and the case.

According to the disclosure, it is possible to suppress the leakage of the fluid and reduce the excitation force of the rotor.

### BRIEF DESCRIPTION OF DRAWINGS

The disclosure will be described with reference to the accompanying drawings, wherein like numbers reference like elements.

FIG. 1 is a partial cross-sectional view of an example taken along an axial direction of a fluid control device according to a first embodiment.

FIG. 2 is a partial cross-sectional view of an example taken along an axial direction of a fluid control device according to the first embodiment.

FIG. 3 is a partial cross-sectional view of an example taken along a surface orthogonal to an axial direction of a fluid control device according to a second embodiment.

FIG. 4 is a partial cross-sectional view of an example taken along a surface orthogonal to an axial direction of a fluid control device according to the second embodiment.

FIG. 5 is a partial cross-sectional view taken along an axial direction of a fluid control device according to a third embodiment.

FIG. 6 is a partial cross-sectional view taken along a surface orthogonal to an axial direction of a fluid control device according to a fourth embodiment.

FIG. 7 is an explanatory diagram regarding pressure distribution in a circumferential direction.

FIG. 8 is a partial cross-sectional view taken along a surface orthogonal to an axial direction of a fluid control device according to a fifth embodiment.

### DESCRIPTION OF EMBODIMENTS

Detailed descriptions will be given below of embodiments according to the present invention on the basis of the drawings. Note that, the invention is not limited to the embodiments. Further, the constituent elements in the following embodiments include those that can be easily replaced by a person skilled in the art or those that are substantially the same. Further, the constituent elements described below can be combined as appropriate, and in the case of a plurality of embodiments, the embodiments can be combined with one another.

### First Embodiment

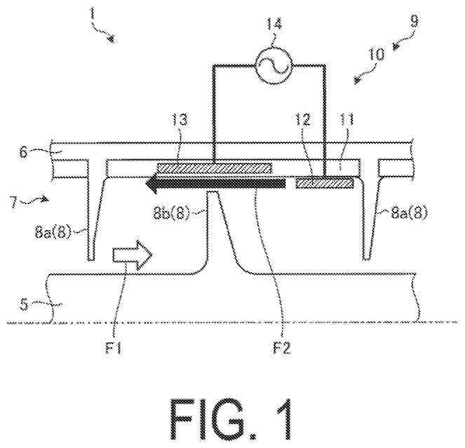

FIG. 1 is a partial cross-sectional view of an example taken along an axial direction of a fluid control device according to a first embodiment. As illustrated in FIG. 1, a fluid control device 9 according to the first embodiment is provided in a rotary machine 1 including a rotor 5 and a case 6 provided around the rotor 5. The rotary machine 1 is, for example, a gas turbine. The rotary machine 1 is not particularly limited to a gas turbine, and may be applied to any equipment as long as the rotary machine 1 includes the rotor 5 and is provided with a sealing portion 7 between the rotor 5 and the case 6.

### Rotary Machine

The rotary machine 1 includes the rotor 5, the case 6, the sealing portion 7, and the fluid control device 9. The rotor 5 rotates in a predetermined rotational direction about a rotation shaft extending in the axial direction. The case 6 is provided with a predetermined gap interposed between the case 6 and the rotor 5, and is formed in an annular shape to surround an outer side in the radial direction of the rotor 5 along the circumferential direction. Thus, a space is formed between the rotor 5 and the case 6. By the rotor 5 rotating in the rotational direction, a fluid such as air in this space flows from one side in the axial direction of the rotor 5 toward the other side, and also flows along the circumferential direction which is the rotational direction of the rotor 5, thereby forming a swirling flow (swirl) F1.

The sealing portion 7 seals the swirling flow F1, which flows from one side in the axial direction of the rotor 5 (the left side in FIG. 1) toward the other side (the right side in FIG. 1). The sealing portion 7 is a labyrinth seal formed of a plurality of seal fins 8. The plurality of seal fins 8 include a seal fin 8a provided to protrude inwards in the radial direction from the case 6, and a seal fin 8b provided to protrude outwards in the radial direction from the rotor 5. The seal fin 8a and the seal fin 8b are alternately provided along the axial direction.

### Fluid Control Device

The fluid control device 9 is a device configured to control the swirling flow F1 generated in the space between the rotor 5 and the case 6. The fluid control device 9 includes a first fluid control device 10 configured to suppress the leakage of the swirling flow F1 in the gap between the seal fin 8b and the case 6 in the axial direction of the rotor 5. In other words, the first fluid control device 10 generates an induced flow F2 in a backflow direction with respect to the flow direction of the swirling flow F1 in the gap between the seal fin 8b and the case 6 in the axial direction of the rotor 5. In the first embodiment, a configuration will be described in which the leakage of the swirling flow F1 from the gap between the seal fin 8b and the case 6 is suppressed, but the configuration may be such that the leakage of the swirling flow F1 from the gap between the seal fin 8a and the rotor 5 is suppressed.

The first fluid control device 10 is a plasma actuator. The first fluid control device 10 is configured to include a first dielectric 11, a first upper electrode 12, a first lower electrode 13, and a first power supply 14.

The first dielectric 11 is formed on a portion of the inner circumferential surface of the case 6 facing the seal fin 8b. Specifically, the first dielectric 11 is provided on a portion of the inner circumferential surface of the case 6 between the seal fins 8a adjacent to each other in the axial direction. The first dielectric 11 is formed as a dielectric layer by coating on the inner circumferential surface of the case 6. The coating is a ceramic coating, for example, and has heat resistance. The first dielectric 11 is provided across the entire circumference in the circumferential direction of the case 6, and is formed in an annular shape.

The first upper electrode 12 is provided on the downstream side in the flow direction of the swirling flow F1 relative to the seal fin 8b in the axial direction of the rotor 5. Specifically, the first upper electrode 12 is provided between the seal fin 8b and the seal fin 8a on the downstream side of the seal fin 8b. The first upper electrode 12 is provided on the first dielectric 11. That is, the first upper electrode 12 is provided being exposed on the inner circumferential surface side of the first dielectric 11.

The first lower electrode 13 is provided on the upstream side in the flow direction of the swirling flow F1 relative to the first upper electrode 12 in the axial direction of the rotor 5. Specifically, the first lower electrode 13 is provided to extend from the upstream side to the downstream side in the flow direction of the swirling flow F1 relative to the seal fin 8b in the axial direction of the rotor 5. In other words, the first lower electrode 13 is provided to extend on both sides of the seal fin 8b in the axial direction of the rotor 5. The first lower electrode 13 is provided inside the first dielectric 11. In other words, the first lower electrode 13 faces the seal fin 8b with the first dielectric 11 interposed therebetween.

The first power supply 14 is an AC power supply and is connected to the first upper electrode 12 and the first lower electrode 13 to apply a voltage thereto. The first power supply 14 generates a dielectric barrier discharge by applying the voltage, thereby generating plasma in a space between the first upper electrode 12 and the first lower electrode 13, from the first upper electrode 12 toward the first lower electrode 13.

The first fluid control device 10 applies a voltage by the first power supply 14 to generate, by the plasma generated in the space between the first upper electrode 12 and the first lower electrode 13, the induced flow F2 flowing from the first upper electrode 12 toward the first lower electrode 13 in the backflow direction. Thus, the first fluid control device 10 suppresses a situation in which the swirling flow F1 flows, to the downstream side, passing through the gap between the seal fin 8b and the case 6, by the generation of the induced flow F2 flowing in the backflow direction against the swirling flow F1 in the axial direction.

As described above, according to the first embodiment, it is possible to generate, by the first fluid control device 10, the induced flow F2 in the backflow direction opposing the swirling flow F1 in the axial direction of the rotor 5. This makes it possible for the first fluid control device 10 to suppress the leakage of the swirling flow F1 through the gap between the seal fin 8b and the case 6. Furthermore, by suppressing the leakage of the swirling flow F1, it is possible to suppress the seal excitation force exerted on the rotor 5 in proportion to the suppression of the seal fin 8b and the case 6 coming close to each other.

In addition, according to the first embodiment, a large structural change of the sealing portion 7 caused by the provision of the first fluid control device 10, can be suppressed by using a plasma actuator as the first fluid control device 10. In other words, the use of a plasma actuator as the first fluid control device 10 makes it easy to provide the first fluid control device 10 for the existing sealing portion 7.

According to the first embodiment, the first lower electrode 13 can be provided extending from the upstream side to the downstream side in the flow direction of the swirling flow F1 relative to the seal fin 8b in the axial direction of the rotor 5. Thus, the swirling flow F1 may be suitably guided from the first upper electrode 12 toward the first lower electrode 13.

In addition, according to the first embodiment, the first dielectric 11 can be easily formed by coating.

In the first embodiment, although the description is given in which the fluid control device 9 is applied to the sealing portion 7 of the rotary machine 1, the fluid control device 9 may be provided in any portion where the fin and the case face each other. For example, the fluid control device 9 may seal a portion between a tip fin provided on the tip end of a rotor blade of a gas turbine and a casing that faces the tip fin.

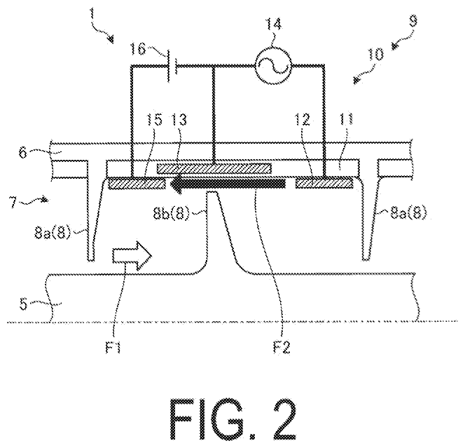

The fluid control device 9 of the first embodiment may have a configuration as illustrated in FIG. 2, for example. The fluid control device 9 in FIG. 2 is configured such that the first fluid control device 10 illustrated in FIG. 1 further includes an electrode 15 and a DC power supply 16. The electrode 15 is provided on the upstream side in the flow direction of the swirling flow F1 relative to the first lower electrode 13 in the axial direction of the rotor 5. Specifically, the electrode 15 is provided between the seal fin 8b and the seal fin 8a on the upstream side of the seal fin 8b. The electrode 15 is provided on the first dielectric 11. That is, the electrode 15 is provided being exposed on the inner circumferential surface side of the first dielectric 11.

The DC power supply 16 is connected to the electrode 15 and a line connecting the first lower electrode 13 and the first power supply 14. The DC power supply 16 attracts the plasma generated in the space between the first upper electrode 12 and the first lower electrode 13 toward the electrode 15 side by applying a DC voltage.

The first fluid control device 10 of FIG. 2 applies the DC voltage by the DC power supply 16 to attract the plasma toward the electrode 15 side, thereby facilitating the flow of the induced flow F2 in the backflow direction.

As described above, according to the fluid control device 9 of FIG. 2, the flow of the induced flow F2 in the backflow direction can be facilitated more, and it is possible to further suppress the leakage of the swirling flow F1 through the gap between the seal fin 8b and the case 6.

### Second Embodiment

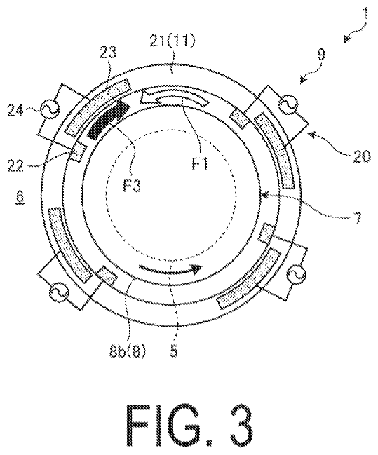

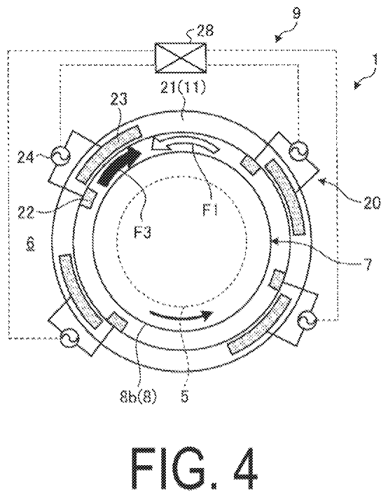

A fluid control device 9 according to a second embodiment will be described next with reference to FIGS. 3 and 4. In the second embodiment, in order to avoid redundant descriptions, descriptions will be given only for structural elements different from those of the first embodiment, and the same reference numerals will be assigned to structural elements having the same configuration as that of the first embodiment. FIGS. 3 and 4 are each a partial cross-sectional view of an example taken along a surface orthogonal to an axial direction of the fluid control device according to the second embodiment.

The fluid control device 9 of the second embodiment includes a second fluid control device 20 instead of the first fluid control device 10.

The second fluid control device 20 is a device configured to control a flow of a swirling flow F1 in a circumferential direction of a rotor 5. Specifically, the second fluid control device 20 generates an induced flow F3 in a backflow direction with respect to a flow direction of the swirling flow F1 in the circumferential direction of the rotor 5. In the second embodiment, although the induced flow F3 is generated in the backflow direction with respect to the flow direction of the swirling flow F1, the induced flow F3 may be generated in a forward flow direction that is the same direction as the flow direction of the swirling flow F1.

The second fluid control device 20 is provided at a position facing a seal fin 8b in the axial direction of the rotor 5. A plurality of the second fluid control devices 20 are provided side-by-side in the circumferential direction of the rotor 5. The plurality of second fluid control devices 20 are arranged at equal intervals in the circumferential direction of the rotor 5. In FIGS. 3 and 4, four second fluid control devices 20 are provided, but the number of pieces thereof is not particularly limited and is sufficient to be at least one.

The second fluid control device 20 is a plasma actuator. The second fluid control device 20 is configured to include a second dielectric 21, a second upper electrode 22, a second lower electrode 23, and a second power supply 24.

The second dielectric 21 is the same as the first dielectric 11, and therefore description thereof will be omitted.

The second upper electrode 22 is provided on the downstream side in the flow direction of the swirling flow F1 relative to the second lower electrode 23 in the circumferential direction of the rotor 5. Specifically, the second upper electrode 22 is provided between the seal fin 8b and a case 6. The second upper electrode 22 is provided on the second dielectric 21. That is, the second upper electrode 22 is provided being exposed on the inner circumferential surface side of the second dielectric 21.

The second lower electrode 23 is provided on the upstream side in the flow direction of the swirling flow F1 relative to the second upper electrode 22 in the circumferential direction of the rotor 5. The second lower electrode 23 is provided extending along the circumferential direction of the rotor 5. The second lower electrode 23 is provided inside the second dielectric 21. In other words, the second lower electrode 23 faces the seal fin 8b with the second dielectric 21 interposed therebetween.

The second power supply 24 is an AC power supply and is connected to the second upper electrode 22 and the second lower electrode 23 to apply a voltage thereto. The second power supply 24 generates a dielectric barrier discharge by applying the voltage, thereby generating plasma in a space between the second upper electrode 22 and the second lower electrode 23, from the second upper electrode 22 toward the second lower electrode 23.

The second fluid control device 20 applies a voltage by the second power supply 24 to generate, by the plasma generated in the space between the second upper electrode 22 and the second lower electrode 23, the induced flow F3 flowing from the second upper electrode 22 toward the second lower electrode 23 in the backflow direction. Thus, the plurality of second fluid control devices 20 generate the induced flow F3 in the backflow direction against the swirling flow F1 in the circumferential direction, thereby suppressing the formation of a non-uniform pressure distribution in the circumferential direction of the rotor 5.

As described above, according to the second embodiment, it is possible to generate, by the second fluid control device 20, the induced flow F3 in the backflow direction opposing the swirling flow F1 in the circumferential direction of the rotor 5. Thus, the second fluid control device 20 may suppress the formation of a non-uniform pressure distribution in the circumferential direction of the rotor 5. Furthermore, by suppressing the formation of the non-uniform pressure distribution, it is possible to suppress the seal excitation force exerted on the rotor 5.

According to the second embodiment, a large structural change of a sealing portion 7 caused by the provision of the second fluid control device 20, can be suppressed by using a plasma actuator as the second fluid control device 20. In other words, the use of a plasma actuator as the second fluid control device 20 makes it easy to provide the second fluid control device 20 for the existing sealing portion 7.

According to the second embodiment, the plurality of second fluid control devices 20 can be provided side-by-side at equal intervals in the circumferential direction of the rotor 5. Thus, the induced flow F3 may be formed uniformly in the circumferential direction of the rotor 5.

In the second embodiment, the induced flow F3 is generated in the backflow direction against the flow direction of the swirling flow F1, but the present invention is not particularly limited thereto. As long as the formation of the non-uniform pressure distribution in the circumferential direction of the rotor can be suppressed, the induced flow F3 may be generated in the forward flow direction that is the same direction as the flow direction of the swirling flow F1, or the induced flow F3 in the backflow direction and the induced flow F3 in the forward flow direction may coexist.

The fluid control device 9 of the second embodiment may have a configuration as illustrated in FIG. 4, for example. The fluid control device 9 in FIG. 4 is configured to be able to separately control the plurality of second fluid control devices 20 illustrated in FIG. 3. That is, the fluid control device 9 in FIG. 4 further includes a controller 28 connected to the plurality of second fluid control devices 20. The controller 28 is connected to the second power supply 24 of each of the plurality of second fluid control devices 20. The controller 28 performs output control on the plurality of second power supplies 24 so as to control, by the plurality of second fluid control devices 20, the formation of the induced flow F3 generated.

A pressure gauge for measuring the pressure distribution in the circumferential direction of the rotor 5 may be connected to the controller 28, for example, or a vibration meter for measuring the vibrations generated in the rotor 5 may be connected to the controller 28. The controller 28 may control the plurality of second fluid control devices 20 based on the measurement result of the pressure gauge or the vibration meter.

As described above, according to the fluid control device 9 in FIG. 4, it is possible to form the induced flow F3 in accordance with the pressure distribution in the circumferential direction of the rotor 5, and thus the formation of a non-uniform pressure distribution can be further suppressed.

### Third Embodiment

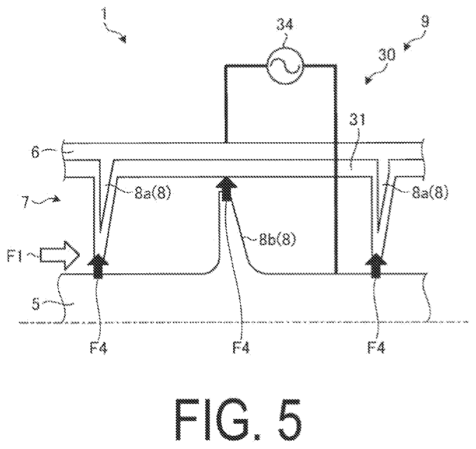

A fluid control device 9 according to a third embodiment will be described next with reference to FIG. 5. In the third embodiment, in order to avoid redundant descriptions, descriptions will be given only for structural elements different from those of the first and second embodiments, and the same reference numerals will be assigned to structural elements having the same configurations as those of the first and second embodiments. FIG. 5 is a partial cross-sectional view taken along an axial direction of the fluid control device according to the third embodiment.

The fluid control device 9 according to the third embodiment is a device configured to control a flow of a swirling flow F1 in a circumferential direction of a rotor 5. Specifically, a third fluid control device 30 generates an induced flow F4 in a direction to block the flow of the swirling flow F1 in an axial direction of the rotor 5.

The third fluid control device 30 is a plasma actuator. The third fluid control device 30 uses the rotor 5 and a seal fin 8b as a third upper electrode, and uses a seal fin 8a and a case 6 as a third lower electrode. For this purpose, the rotor 5, the case 6, and the seal fins 8a and 8b use a metal material capable of functioning as an electrode. The rotor 5 and the seal fin 8b are electrically connected, and similarly, the case 6 and the seal fin 8a are electrically connected. The third fluid control device 30 is configured to include a third dielectric 31, the rotor 5 and the seal fin 8b functioning as the third upper electrode, the seal fin 8a and the case 6 functioning as the third lower electrode, and a third power supply 34. Since the rotor 5 and the seal fins 8a and 8b are the same as those of the first embodiment, descriptions thereof will be omitted.

The third dielectric 31 is formed on the entire inner circumferential surface of the case 6. The third dielectric 31, similarly to the first dielectric 11, is formed as a dielectric layer by coating on the inner circumferential surface of the case 6.

The third power supply 34 is an AC power supply and is connected to the rotor 5 and the case 6 to apply a voltage thereto. The third power supply 34 generates a dielectric barrier discharge by applying the voltage, thereby generating plasma in a space between the rotor 5 and the seal fin 8a and a space between the seal fin 8b and the case 6, from the rotor 5 side toward the case 6 side.

The third fluid control device 30 applies a voltage by the third power supply 34 to generate, by the plasma generated in the space between the rotor 5 and the seal fin 8a and the space between the seal fin 8b and the case 6, the induced flows F4 flowing from the rotor 5 side toward the case 6 side in the radial direction. Thus, by the generation of the induced flow F4 in the radial direction, the third fluid control device 30 suppresses a situation in which the swirling flow F1 flows, to the downstream side, passing through a gap between the rotor 5 and the seal fin 8a and a gap between the seal fin 8b and the case 6.

As described above, according to the third embodiment, it is possible to generate, by the third fluid control device 30, the induced flow F4 in a direction to block the flow of the swirling flow F1 in the radial direction of the rotor 5. This makes it possible for the third fluid control device 30 to suppress the leakage of the swirling flow F1 through the gap between the rotor 5 and the seal fin 8a and the gap between the seal fin 8b and the case 6. Furthermore, by suppressing the leakage of the swirling flow F1, it is possible to suppress the seal excitation force exerted on the rotor 5 in proportion to the suppression of the seal fin 8b and the case 6 coming close to each other and the suppression of the rotor 5 and the seal fin 8a coming close to each other.

According to the third embodiment, a large structural change of a sealing portion 7 caused by the provision of the third fluid control device 30, can be suppressed by using a plasma actuator as the third fluid control device 30. In other words, the use of a plasma actuator as the third fluid control device 30 makes it easy to provide the third fluid control device 30 for the existing sealing portion 7.

### Fourth Embodiment

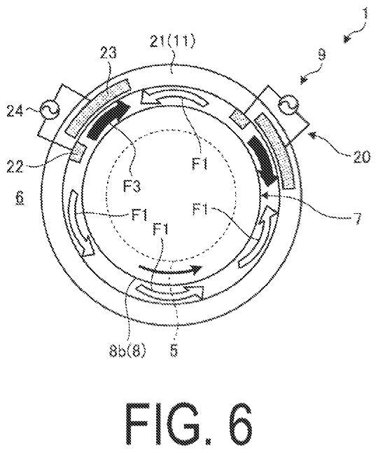

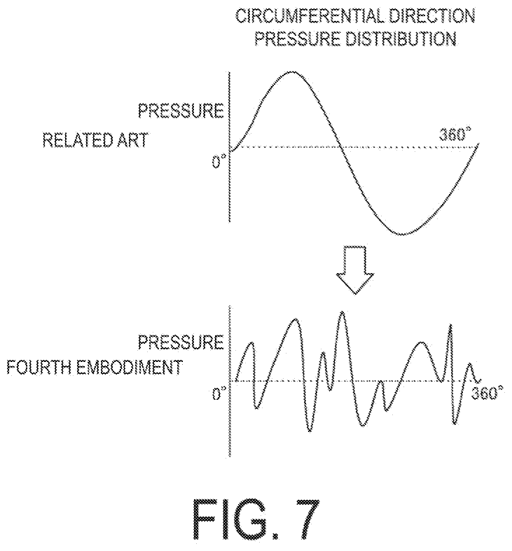

A fluid control device 9 according to a fourth embodiment will be described next with reference to FIGS. 6 and 7. In the fourth embodiment, in order to avoid redundant descriptions, descriptions will be given only for structural elements different from those of the first to third embodiments, and the same reference numerals will be assigned to structural elements having the same configuration as those of the first to third embodiments. FIG. 6 is a partial cross-sectional view taken along a surface orthogonal to an axial direction of the fluid control device according to the fourth embodiment. FIG. 7 is an explanatory diagram regarding pressure distribution in a circumferential direction.

In the fluid control device 9 according to the fourth embodiment, the plurality of second fluid control devices 20 according to the second embodiment are arranged side-by-side in the circumferential direction at unequal intervals. In FIG. 6, two second fluid control devices 20 are provided, but the number of pieces thereof is not particularly limited and is sufficient to be more than one.

Pressure distribution in the circumferential direction of a rotor 5 of the related art and pressure distribution in the circumferential direction of a rotor 5 of the fourth embodiment will be described with reference to FIG. 7. In the related art, a rotary machine 1 is configured not to include the second fluid control device 20. In FIG. 7, the horizontal axis represents a position in the circumferential direction of the rotor 5, and the vertical axis represents the pressure. In the related art, the pressure distribution in the circumferential direction of the rotor 5 exhibits a periodic (regulated) change in wave shape such as a sinusoidal curve. In the related art, the pressure at a phase of 90 degrees is highest and the pressure at a phase of 270 degrees is lowest, in the circumferential direction of the rotor 5. Due to this, the rotor 5 is displaced in the radial direction from a position at 90 degrees in the circumferential direction toward a position at 270 degrees in the circumferential direction, and thus a seal excitation force is exerted on the rotor 5. In the fourth embodiment, because the second fluid control devices 20 are arranged at unequal intervals in the circumferential direction of the rotor 5, the pressure distribution in the circumferential direction of the rotor 5 exhibits an irregular change. As a result, the rotor 5 is unlikely to be displaced in the radial direction, and it is possible to suppress the generation of the seal excitation force.

As described above, according to the fourth embodiment, it is possible to cause the pressure distribution in the circumferential direction of the rotor 5 to exhibit an irregular change, by the plurality of second fluid control devices 20 being arranged at the unequal intervals. Furthermore, by forming the pressure distribution exhibiting an irregular change, it is possible to suppress the seal excitation force being exerted on the rotor 5.

### Fifth Embodiment

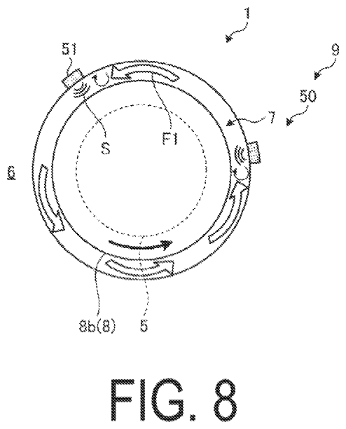

A fluid control device 9 according to a fifth embodiment will be described next with reference to FIG. 8. In the fifth embodiment, in order to avoid redundant descriptions, descriptions will be given only for structural elements different from those of the first to fourth embodiments, and the same reference numerals will be assigned to structural elements having the same configuration as those of the first to fourth embodiments. FIG. 8 is a partial cross-sectional view taken along a surface orthogonal to an axial direction of the fluid control device according to the fifth embodiment.

The fluid control device 9 according to the fifth embodiment has a configuration in which the plurality of second fluid control devices 20 according to the fourth embodiment are changed in such a manner that the plasma actuators are replaced with ultrasonic wave generators. In other words, in the fluid control device 9 according to the fifth embodiment, a plurality of second fluid control devices 50 arranged at unequal intervals in the circumferential direction of a rotor 5 are configured using ultrasonic wave generators 51.

The ultrasonic wave generator 51 is provided in a case 6 and irradiates a seal fin 8b with ultrasonic waves S, thereby disturbing an airflow in a space between the case 6 and the seal fin 8b. By disturbing the airflow by the plurality of second fluid control devices 50, the pressure distribution in the circumferential direction of the rotor 5 exhibits an irregular change. As a result, the rotor 5 is unlikely to be displaced in the radial direction, and it is possible to suppress the generation of the seal excitation force.

As described above, according to the fifth embodiment, it is possible to cause the pressure distribution in the circumferential direction of the rotor 5 to exhibit an irregular change, by the plurality of second fluid control devices 50 being arranged at the unequal intervals. Furthermore, by forming the pressure distribution exhibiting an irregular change, it is possible to suppress the seal excitation force being exerted on the rotor 5.

The second fluid control device 50 is configured by using the ultrasonic wave generator 51 in the fifth embodiment, and the first fluid control device 10 and the third fluid control device 30 may be configured by using the ultrasonic wave generator 51.

The fluid control device 9 may also have a configuration in which the first fluid control device 10, the second fluid control device 20, and the third fluid control device 30 are appropriately combined.

The fluid control device 9 and the rotary machine 1 described in each of the embodiments are construed as follows, for example.

The fluid control device 9 according to a first aspect is a fluid control device 9 included in the rotary machine 1 including a rotor 5, a case 6 provided to surround an outer side of the rotor 5, and a fin (seal fin 8) provided to protrude from at least one of the rotor 5 or the case 6, and configured to control a fluid (a swirling flow F1) that flows between the fin and the rotor 5 or between the fin and the case 6, the fluid control device including a first fluid control device 10 configured to generate an induced flow F2 in a backflow direction opposite to a flow direction of the fluid in an axial direction of the rotor 5.

According to this configuration, it is possible to generate, by the first fluid control device 10, the induced flow F2 in the backflow direction opposing the swirling flow F1 in the axial direction of the rotor 5. This makes it possible for the first fluid control device 10 to suppress the leakage of the swirling flow F1 through the gap between the fin and the case 6. Furthermore, by suppressing the leakage of the swirling flow F1, it is possible to suppress a seal excitation force exerted on the rotor 5 in proportion to the suppression of the fin and the case 6 coming close to each other.

As a second aspect, the first fluid control device 10 is a plasma actuator, and includes a first dielectric 11 provided on a portion of the rotor 5 or the case 6 facing the fin, a first upper electrode 12 provided on a downstream side in a flow direction of the fluid relative to the fin in the axial direction of the rotor 5, a first lower electrode 13 provided on an upstream side in the flow direction of the fluid relative to the first upper electrode 12 in the axial direction of the rotor 5, and a first power supply 14 connected to the first upper electrode 12 and the first lower electrode 13, thereby generating an induced flow F2 flowing from the first upper electrode 12 toward the first lower electrode 13 in the backflow direction.

According to this configuration, a large structural change involving the fin caused by the provision of the first fluid control device 10, may be suppressed by using a plasma actuator as the first fluid control device 10. To rephrase, the use of a plasma actuator as the first fluid control device 10 makes it easy to provide the first fluid control device 10 for the existing configuration involving the fin.

As a third aspect, the first lower electrode 13 is provided to extend from the upstream side to the downstream side in the flow direction of the fluid relative to the fin in the axial direction of the rotor 5.

According to this configuration, the first lower electrode 13 may be provided extending from the upstream side to the downstream side in the flow direction of the swirling flow F1 relative to the fin in the axial direction of the rotor 5. Thus, the swirling flow F1 may be suitably guided from the first upper electrode 12 toward the first lower electrode 13.

As a fourth aspect, there is further provided a second fluid control device 20 configured to generate an induced flow F3 in a circumferential direction of the rotor 5.

According to this configuration, it is possible to generate, by the second fluid control device 20, the induced flow F3 in the circumferential direction of the rotor 5. Thus, the second fluid control device 20 may suppress the formation of a non-uniform pressure distribution in the circumferential direction of the rotor 5. Furthermore, by suppressing the formation of the non-uniform pressure distribution, it is possible to suppress the excitation force exerted on the rotor 5.

As a fifth aspect, the second fluid control device 20 is a plasma actuator, and includes a second dielectric 21 provided on a portion of the rotor 5 or the case 6 facing the fin, a second upper electrode 22 provided on one of the upstream side and the downstream side in the flow direction of the fluid in the circumferential direction of the rotor 5, a second lower electrode 23 provided on the other one of the upstream side and the downstream side in the flow direction of the fluid in the circumferential direction of the rotor 5, and a second power supply 24 connected to the second upper electrode 22 and the second lower electrode 23, thereby generating the induced flow F3 in a direction from the second upper electrode 22 toward the second lower electrode 23.

According to this configuration, a large structural change involving the fin caused by the provision of the second fluid control device 20, may be suppressed by using a plasma actuator as the second fluid control device 20. To rephrase, the use of a plasma actuator as the second fluid control device 20 makes it easy to provide the second fluid control device 20 for the existing configuration involving the fin.

As a sixth aspect, the second upper electrode 22 is provided on the downstream side in the flow direction of the fluid, and the second lower electrode 23 is provided on the upstream side in the flow direction of the fluid.

According to this configuration, it is possible to generate the induced flow F3 in the backflow direction opposing the swirling flow F1. Thus, the second fluid control device 20 may further suppress the formation of a non-uniform pressure distribution in the circumferential direction of the rotor 5.

As a seventh aspect, a plurality of the second fluid control devices 20 are provided side-by-side in the circumferential direction and are arranged at equal intervals.

According to this configuration, it is possible to uniformly form the induced flow F3 in the circumferential direction of the rotor 5.

As an eighth aspect, the plurality of second fluid control devices 20 are provided side-by-side in the circumferential direction and are arranged at unequal intervals.

According to this configuration, it is possible to cause the pressure distribution in the circumferential direction of the rotor 5 to exhibit an irregular change, by the plurality of second fluid control devices 20 being arranged at the unequal intervals. Furthermore, by forming the pressure distribution exhibiting an irregular change, it is possible to suppress the excitation force being exerted on the rotor 5.

As a ninth aspect, there is further provided a controller 28 configured to separately control the plurality of second fluid control devices 20.

According to this configuration, it is possible to form the induced flow F3 in accordance with the pressure distribution in the circumferential direction of the rotor 5, and thus the formation of a non-uniform pressure distribution can be further suppressed.

As a tenth aspect, there is further provided a third fluid control device 30 configured to generate an induced flow F4 in a radial direction of the rotor 5.

According to this configuration, it is possible to generate, by the third fluid control device 30, the induced flow F4 in a direction to block the flow of the swirling flow F1 in the radial direction of the rotor 5. This makes it possible for the third fluid control device 30 to suppress the leakage of the swirling flow F1 through the gap between the rotor 5 and the fin and the gap between the fin and the case 6. Furthermore, by suppressing the leakage of the swirling flow F1, it is possible to suppress the excitation force exerted on the rotor 5 in proportion to the suppression of the fin and the case 6 coming close to each other and the suppression of the rotor 5 and the fin coming close to each other.

As an eleventh aspect, the third fluid control device 30 includes a third dielectric 31 provided on a portion of the rotor or the case facing the fin, a third upper electrode (the rotor 5 and a seal fin 8b) provided on the rotor side in the radial direction of the rotor, a third lower electrode (the case 6 and a seal fin 8a) provided on the case side in the radial direction of the rotor, and a third power supply 34 connected to the third upper electrode and the third lower electrode, thereby generating the induced flow F4 in a direction from the third upper electrode toward the third lower electrode.

According to this configuration, a large structural change involving the fin caused by the provision of the third fluid control device 30, may be suppressed by using a plasma actuator as the third fluid control device 30. To rephrase, the use of a plasma actuator as the third fluid control device 30 makes it easy to provide the third fluid control device 30 for the existing configuration involving the fin.

The fluid control device 9 according to a twelfth aspect is a fluid control device 9 included in the rotary machine 1 including a rotor 5, a case 6 provided to surround an outer side of the rotor 5, and a fin (seal fin 8) provided to protrude from at least one of the rotor 5 or the case 6, and configured to control a fluid (swirling flow F1) that flows between the fin and the rotor 5 or between the fin and the case 6, the fluid control device 9 including a second fluid control device 20 configured to generate an induced flow F3 in a circumferential direction of the rotor 5.

According to this configuration, it is possible to generate, by the second fluid control device 20, the induced flow F3 in the circumferential direction of the rotor 5. Thus, the second fluid control device 20 may suppress the formation of a non-uniform pressure distribution in the circumferential direction of the rotor 5. Furthermore, by suppressing the formation of the non-uniform pressure distribution, it is possible to suppress the excitation force exerted on the rotor 5.

The fluid control device 9 according to a thirteenth aspect is a fluid control device 9 included in the rotary machine 1 including a rotor 5, a case 6 provided to surround an outer side of the rotor 5, and a fin (seal fin 8) provided to protrude from at least one of the rotor 5 or the case 6, and configured to control a fluid (swirling flow F1) that flows between the fin and the rotor 5 or between the fin and the case 6, the fluid control device 9 including a third fluid control device 30 configured to generate an induced flow F4 in a radial direction of the rotor 5.

According to this configuration, it is possible to generate, by the third fluid control device 30, the induced flow F4 in a direction to block the flow of the swirling flow F1 in the radial direction of the rotor 5. This makes it possible for the third fluid control device 30 to suppress the leakage of the swirling flow F1 through the gap between the rotor 5 and the fin and the gap between the fin and the case 6. Furthermore, by suppressing the leakage of the swirling flow F1, it is possible to suppress the excitation force exerted on the rotor 5 in proportion to the suppression of the fin and the case 6 coming close to each other and the suppression of the rotor 5 and the fin coming close to each other.

As a fourteenth aspect, the fin is the seal fin 8 used in a labyrinth seal configured to seal a portion between the rotor 5 and the case 6.

According to this configuration, because the fin is applicable as the seal fin 8, it is possible to suppress the seal excitation force exerted on the rotor 5.

The rotary machine 1 according to a fifteenth aspect includes a rotor 5, a case 6 provided to surround an outer side of the rotor 5, fins (a seal fin 8a and a seal fin 8b) each provided to protrude from at least one of the rotor 5 or the case 6, and the above-described fluid control device 9 configured to control a fluid (a swirling flow F1) that flows between the fin and the rotor 5 or between the fin and the case 6.

According to this configuration, because the generation of the excitation force exerted on the rotor 5 can be suppressed by the fluid control device 9, it is possible for the rotary machine 1 to have high rotation stability.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A fluid control device included in a rotary machine including a rotor, a case provided to surround an outer side of the rotor, and a fin provided to protrude from at least one of the rotor or the case, and configured to control a fluid that flows between the fin and the rotor or between the fin and the case, the fluid control device comprising:
a first fluid control device configured to generate an induced flow in a backflow direction opposite to a flow direction of the fluid in an axial direction of the rotor.

2. The fluid control device according to claim 1,
wherein the first fluid control device is a plasma actuator, and includes,
a first dielectric provided on a portion of the rotor or the case facing the fin,
a first upper electrode provided on a downstream side in a flow direction of the fluid relative to the fin in the axial direction of the rotor,
a first lower electrode provided on an upstream side in the flow direction of the fluid relative to the first upper electrode in the axial direction of the rotor, and
a first power supply connected to the first upper electrode and the first lower electrode, and
the first fluid control device generates an induced flow flowing from the first upper electrode toward the first lower electrode in the backflow direction.

3. The fluid control device according to claim 2,
wherein the first lower electrode is provided to extend from the upstream side to the downstream side in the flow direction of the fluid relative to the fin in the axial direction of the rotor.

4. The fluid control device according to claim 1, further comprising:
a second fluid control device configured to generate an induced flow in a circumferential direction of the rotor.

5. The fluid control device according to claim 4,
wherein the second fluid control device is a plasma actuator, and includes,
a second dielectric provided on a portion of the rotor or the case facing the fin,
a second upper electrode provided on one of the upstream side and the downstream side in the flow direction of the fluid in the circumferential direction of the rotor,
a second lower electrode provided on the other one of the upstream side and the downstream side in the flow direction of the fluid in the circumferential direction of the rotor, and
a second power supply connected to the second upper electrode and the second lower electrode, and
the second fluid control device generates an induced flow in a direction from the second upper electrode toward the second lower electrode.

6. The fluid control device according to claim 5,
wherein the second upper electrode is provided on the downstream side in the flow direction of the fluid, and
the second lower electrode is provided on the upstream side in the flow direction of the fluid.

7. The fluid control device according to claim 4,
wherein a plurality of the second fluid control devices are provided side-by-side in the circumferential direction and are arranged at equal intervals.

8. The fluid control device according to claim 7, further comprising: a controller configured to separately control the plurality of second fluid control devices.

9. The fluid control device according to claim 4,
wherein a plurality of the second fluid control devices are provided side-by-side in the circumferential direction and are arranged at unequal intervals.

10. The fluid control device according to claim 9, further comprising:
a controller configured to separately control the plurality of second fluid control devices.

11. The fluid control device according to claim 1, further comprising:
a third fluid control device configured to generate an induced flow in a radial direction of the rotor.

12. The fluid control device according to claim 11,
wherein the third fluid control device includes,
a third dielectric provided on a portion of the rotor or the case facing the fin,
a third upper electrode provided on the rotor side in the radial direction of the rotor,
a third lower electrode provided on the case side in the radial direction of the rotor, and
a third power supply connected to the third upper electrode and the third lower electrode, and
the third fluid control device generates an induced flow in a direction from the third upper electrode toward the third lower electrode.

13. The fluid control device according to claim 1,
wherein the fin is a seal fin used in a labyrinth seal configured to seal a portion between the rotor and the case.

14. A rotary machine comprising:
a rotor;
a case provided to surround an outer side of the rotor;
a fin provided to protrude from at least one of the rotor or the case; and the fluid control device according to claim 1 configured to control a fluid that flows between the fin and the rotor or between the fin and the case.

15. A fluid control device included in a rotary machine including a rotor, a case provided to surround an outer side of the rotor, and a fin provided to protrude from at least one of the rotor or the case, and configured to control a fluid that flows between the fin and the rotor or between the fin and the case, the fluid control device comprising:
a second fluid control device configured to generate an induced flow in a circumferential direction of the rotor.

16. The fluid control device according to claim 15,
wherein the fin is a seal fin used in a labyrinth seal configured to seal a portion between the rotor and the case.

17. A rotary machine comprising:
a rotor;
a case provided to surround an outer side of the rotor;
a fin provided to protrude from at least one of the rotor or the case; and the fluid control device according to claim 15 configured to control a fluid that flows between the fin and the rotor or between the fin and the case.

18. A fluid control device included in a rotary machine including a rotor, a case provided to surround an outer side of the rotor, and a fin provided to protrude from at least one of the rotor or the case, and configured to control a fluid that flows between the fin and the rotor or between the fin and the case, the fluid control device comprising:
a third fluid control device configured to generate an induced flow in a radial direction of the rotor.

19. The fluid control device according to claim 18,
wherein the fin is a seal fin used in a labyrinth seal configured to seal a portion between the rotor and the case.

20. A rotary machine comprising:
a rotor;
a case provided to surround an outer side of the rotor;
a fin provided to protrude from at least one of the rotor or the case; and
the fluid control device according to claim 18 configured to control a fluid that flows between the fin and the rotor or between the fin and the case.
